(19) United States
(12) Patent Application Publication
(10) Pub. No.: US 2014/0084612 A1
(43) Pub. Date: Mar. 27, 2014

(54) Continuously Adjustable Lifting Hook for Coils of Varying Width

(71) Applicant: Jonathan F. Eastall, Sherwood (AU)

(72) Inventor: Jonathan F. Eastall, Sherwood (AU)

(21) Appl. No.: 13/912,227

(22) Filed: Jun. 7, 2013

(30) Foreign Application Priority Data
Jun. 8, 2012 (AU) 2012902407

(51) Int. Cl. B66C 1/24

(52) U.S. Cl. CPC B66C 1/24
USPC 294/82.1

(57) ABSTRACT

A lifting hook is provided for balanced lifting of coils of rolled sheet metal of varying widths. The lifting hook has a lifting frame that includes a lower arm with a forward end for penetrating a lumen of a coil. A counterweight is provided that slides along a forward portion of an upper arm of the frame. A lifting assembly also slides on the frame and is arranged to move intermediate the counterweight and a rearward portion of the frame. A leadscrew assembly including a first leadscrew and a second leadscrew having first and second pitches respectively is provided. The first leadscrew is threadedly engaged by the counterweight and the second leadscrew is threadedly engaged by the lifting assembly. The second leadscrew has a pitch that is twice the first leadscrew pitch.

### CROSS REFERENCE TO RELATED APPLICATION

This application takes priority from and claims the benefit of Australian Patent Application No. AU 2012902407 filed on Jun. 8, 2012, the contents of which are herein incorporated by reference.

### TECHNICAL FIELD

The present invention relates to a lifting hook. Embodiments of the invention are particularly applicable to situations where heavy rolls of material, for example steel coils, must be lifted.

### BACKGROUND

Any references to methods, apparatus or documents of the prior art are not to be taken as constituting any evidence or admission that they formed, or form part of the common general knowledge.

Sheets of steel are frequently supplied in the form of coils or rolls as shown in FIG. 1. It will be appreciated that these coils are very heavy and typically require the use of a crane or other heavy machinery to move them. In order to uncoil the steel it is usual to mount the coil on an expanding uncoiler mandrel as shown in FIG. 2. Lifting and positioning a coil on a mandrel is problematic however. In the absence of a coil car, one approach is to use a spreader bar with droppers and an interconnecting removable steel tie bar through the hub coil. This existing method typically requires maneuvering the heavy tie bar into and out of the coil hub which may be above eye height and which poses safety issues since manual handling may be required at reach extension.

Another approach that has been used in the past is to use one tine of a forklift to carry the coil to the mandrel however this method is discouraged as it potentially renders the forklift unstable. Another way to load a coil on a mandrel is with a standard C hook having a narrow foot to suit a small mandrel aperture. However a problem arises with this method as a standard C hook will only suit one size coil.

Some operators may make use of coils with several different widths so that a number of correspondingly sized C hooks would be required to cater for each coil width. Apart from the prohibitive cost involved in acquiring and keeping a range of C hooks it is time and labour intensive to change from one hook to another.

It will be realized that in order to mount the coil onto the un-coiler mandrel it is important that that bore of the coil be kept horizontal since if it is tilted it will be difficult to locate the bore over the mandrel.

It is an object of the present invention to provide a lifting hook that addresses the above described problem and is an improvement, or at least a useful alternative, to lifting hooks of the prior art.

### SUMMARY OF THE INVENTION

According to a first aspect of the present invention there is provided a lifting hook for lifting coils of varying widths comprising:
a lifting frame including a lower arm having a forward end for penetrating a lumen of a coil;
a counterweight assembly arranged to move through a range of positions above the lower arm;
a lifting point assembly arranged to move intermediate a counterweight of the counterweight assembly and a rearward portion of the frame; and
a mechanical linkage constraining movement of the lifting point assembly relative to the counterweight assembly,
wherein the counterweight assembly is constrained to move at a greater speed than the lifting point assembly.

Preferably the mechanical linkage is arranged to maintain the lifting point assembly over a center of gravity of the lifting hook throughout said range of positions of the counterweight assembly.

In a preferred embodiment of the invention the lifting hook includes a coil placement member fast with the counterweight assembly for abutting an inner side of the coil to thereby position the counterweight assembly relative to the coil in a loaded configuration.

The linkage is preferably arranged to constrain the movements of the lifting point assembly relative to the counterweight assembly so that the lifting point assembly moves half a distance moved by the counterweight assembly in use.

In a first embodiment the mechanical linkage comprises first and second crank sliders interconnecting the counterweight assembly and the lifting assembly.

Alternatively, in a preferred embodiment of the invention the mechanical linkage comprises a leadscsrew assembly including a first leadscrew and a second leadscrew having first and second pitches respectively wherein the first leadscrew is threadedly engaged by the counterweight assembly and the second leadscrew is threadedly engaged by the lifting assembly.

In the preferred embodiment of the invention the second pitch is twice the first pitch.

Preferably the lifting hook is provided with markings for positioning the placement member at locations for balanced loading of coils of different widths.

According to a further aspect of the present invention there is provided a lifting hook for lifting coils of varying widths comprising:
a lifting frame including a lower arm having a forward end for penetrating a lumen of a coil;
a counterweight assembly arranged to move through a range of positions above the lower arm;
a lifting assembly arranged to move intermediate a counterweight of the counterweight assembly and a rearward portion of the frame; and
a leadscsrew assembly including a first leadscrew and a second leadscrew having first and second pitches respectively wherein the first leadscrew is threadedly engaged by the counterweight assembly and the second leadscrew is threadedly engaged by the lifting assembly and wherein the second leadscrew pitch is twice the first leadscrew pitch.

Preferably the lifting hook assembly includes a coil placement member extending downward from the counterweight assembly for abutting an inner side of the coil to thereby position the counterweight assembly relative to the coil in a loaded configuration; and
coil positioning markings upon the lifting frame for assisting an operator to bring the coil placement member to a position for balanced loading of coils of predetermined width.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 depicts a coil of sheet metal as is known in the prior art.

FIG. 2 depicts an uncoiler mandrel as is known in the prior art.

FIG. 3 is a side view of a lifting hook according to a first embodiment of the present invention in a first configuration for loading of a narrow width coil.

FIG. 3A is a non-planar view of the lifting hook of FIG. 3 in a second configuration and loaded with a wide width coil.

FIG. 4 is a side view in detail of a portion of the lifting hook of FIG. 3 with hidden lines being represented.

FIG. 5 is a side view of the lifting hook in the first configuration showing its center of gravity.

FIG. 6 is a side view of the lifting hook in the second configuration showing its center of gravity.

FIG. 7 is a side view of the lifting hook of FIG. 3 loaded with the narrow width coil.

FIG. 7A is an isometric view of the lifting hook of FIG. 7.

FIG. 8 is a side view of the lifting hook of FIG. 3 loaded with a wide width coil.

FIG. 8A is an isometric view of the lifting hook of FIG. 8.

FIG. 9 is an isometric view of a lifting hook according to a second and preferred embodiment of the present invention.

FIG. 10 is a close up and partially cutaway view of the lifting hook of FIG. 9.

FIG. 11 is an exploded view of the lifting hook of FIG. 9.

FIG. 12 depicts a leadscrew assembly of the lifting hook of FIG. 9.

FIG. 13 is a top plan view of the lifting hook of FIG. 9.

FIG. 14 is a side view of a sagittal plane through the lifting hook.

FIG. 15 is a detailed view of a portion of FIG. 14.

FIG. 16 shows the lifting hook of FIG. 9 in use supporting a wide width coil.

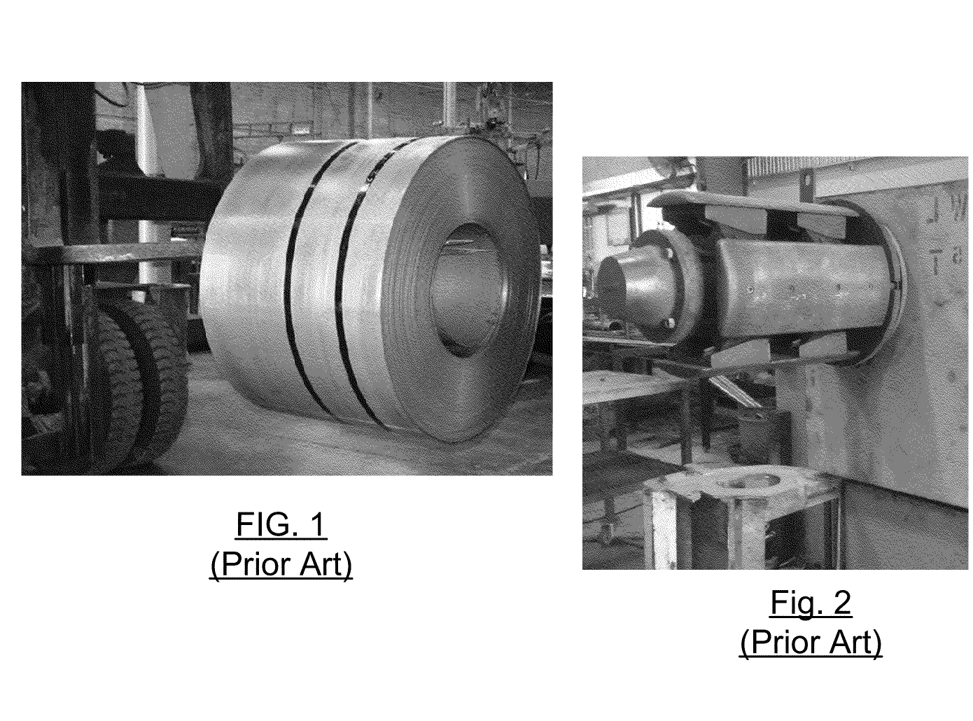

### DETAILED DESCRIPTION OF PREFERRED EMBODIMENTS

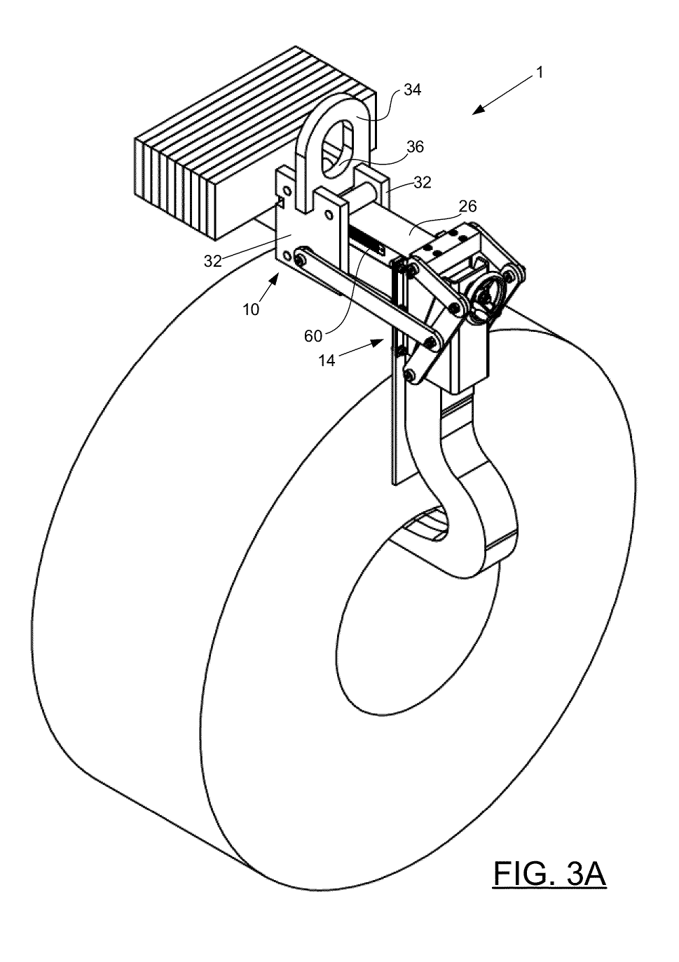

Referring now to FIG. 3, there is depicted a lifting hook 1 according to a first embodiment of the present invention for lifting coils of varying widths. The lifting hook 1 includes a lifting frame 2 that has a lower arm 4 having a forward end 6 for penetrating a lumen of a coil. The lifting frame 2 also includes an upper arm 18. The lower arm 4 and the upper arm 18 are joined by a substantially vertical rearward spacing portion 12.

A counterweight assembly 8 is located over the upper arm 18 and arranged to slide through a range of positions over the upper arm and so also above the lower arm 4. The counterweight assembly 8 includes a forwardly positioned counterweight 24 and a coil placement member 27. The coil placement member 27 comprises a plate that depends downward from the counterweight assembly and which is designed to abut against a face of the coil as will be explained shortly. The coil placement member and the counterweight are located at either ends of counterweight assembly 8.

The slide 26 comprises an elongate bar that slides over the top of the upper arm 18 by virtue of a roller 29 that is mounted thereto.

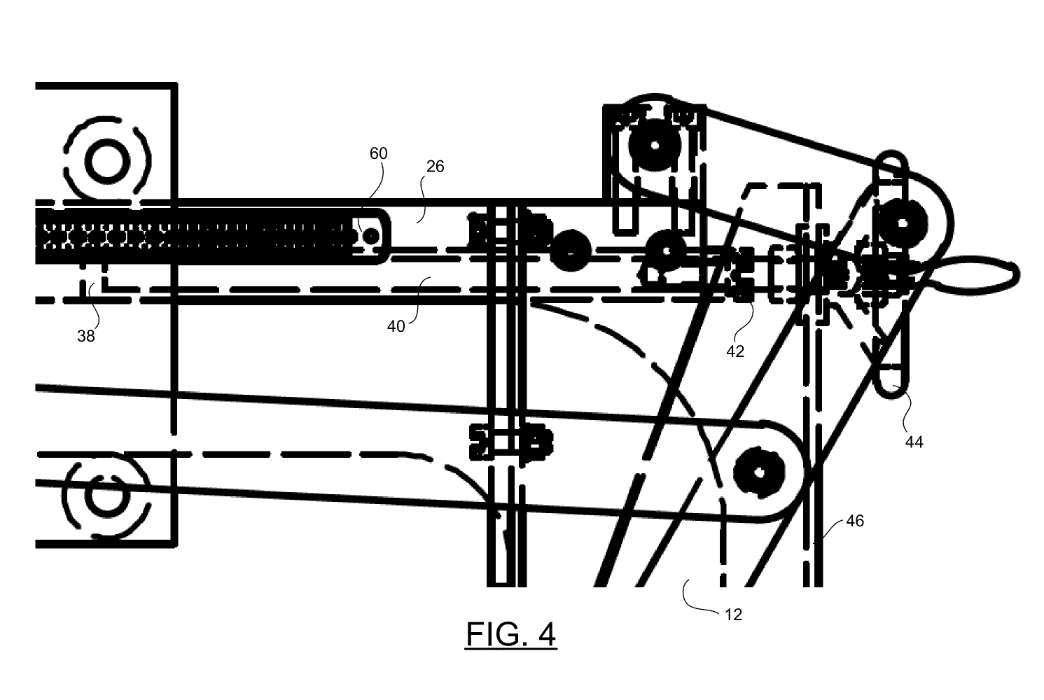

With reference to FIG. 4, the slide 26 is formed with a longitudinal bore 38 that receives a shaft 40. A nut 42 is fastened at the entrance to bore 38 and the shaft 40 is threadedly engaged by the nut 42. A rearward end of shaft 40 terminates in an operator wheel 44. The rearward end is supported and captured by a bracket 46 that is fastened to the rearward portion 12 of frame 2. Consequently, upon an operator rotating handle 44 clockwise or counterclockwise the shaft 40 rotates within nut 42 and so draws slide 26, and hence the entire counterweight assembly 8 including placement member 27 and counterweight 24, back and forth.

Referring again to FIG. 3 and FIG. 3B, a lifting point assembly 10 is arranged to move intermediate the counterweight 24, and the rearward portion 12 of the frame. The lifting point assembly includes upper rollers 28, which roll on slide 26 and lower rollers 30 which abut the underside of upper arm 18. The rollers are mounted at opposite ends between spacing plates 32. The spacing plates 32 are fastened to an upwardly projecting lug 34 which is formed with a lifting eye 36. In use a hook of a crane is received by eye 36 in order for the lifting hook 1 to be raised.

As shown in FIG. 3, a mechanical linkage 14 is provided which constrains movement of the lifting point assembly 10 relative to the counterweight assembly 8. The linkage 14 comprises a crank 50 which at one end is coupled to pivot 48 that is fast with the frame 2. The crank 50 is respectively pivotally coupled to lifting point assembly 10 and counterweight assembly 8 by means of connecting members 52 and 54. It will therefore be recognized that crank 50, connecting member 54 and counterweight assembly 8 comprise a first slider-crank assembly. Furthermore the same crank 50, connecting member 52 and lifting point assembly 10 form a second slider-crank assembly.

The lifting point assembly connecting member 52 is attached to crank 50 at pivot point 56 whereas the counterweight assembly connecting member 54 is attached to crank 50 at pivot point 58.

Since the distance from the crank pivot point 48 to pivot 58 is about twice the distance between pivot point 48 and pivot 56, sliding of the counterweight assembly 8 through a given distance causes the lifting point assembly 10 to slide through half that distance.

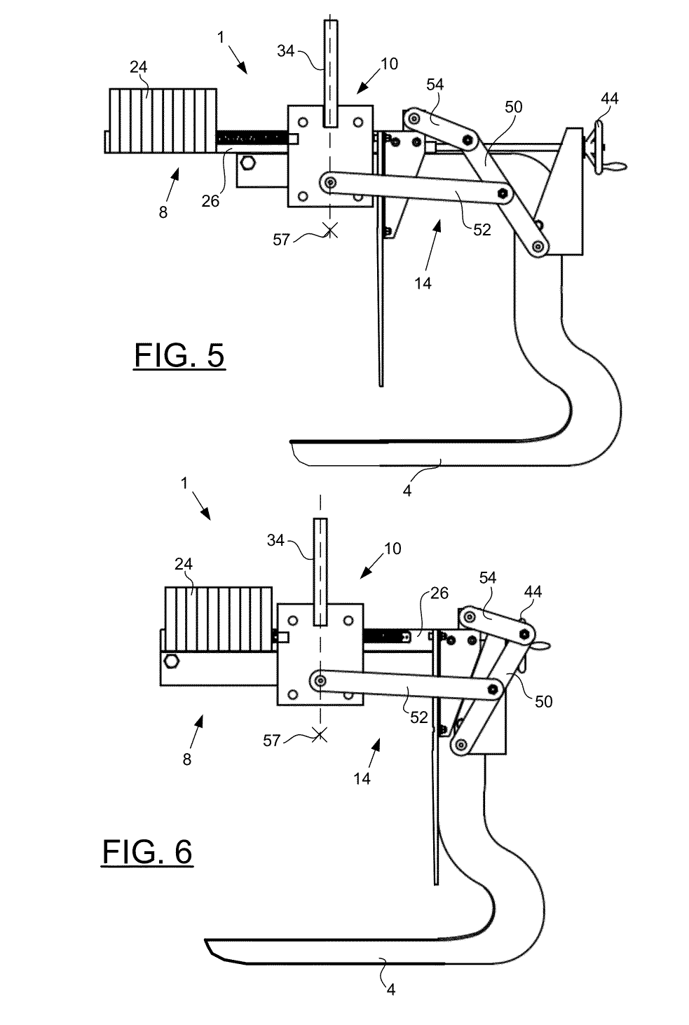

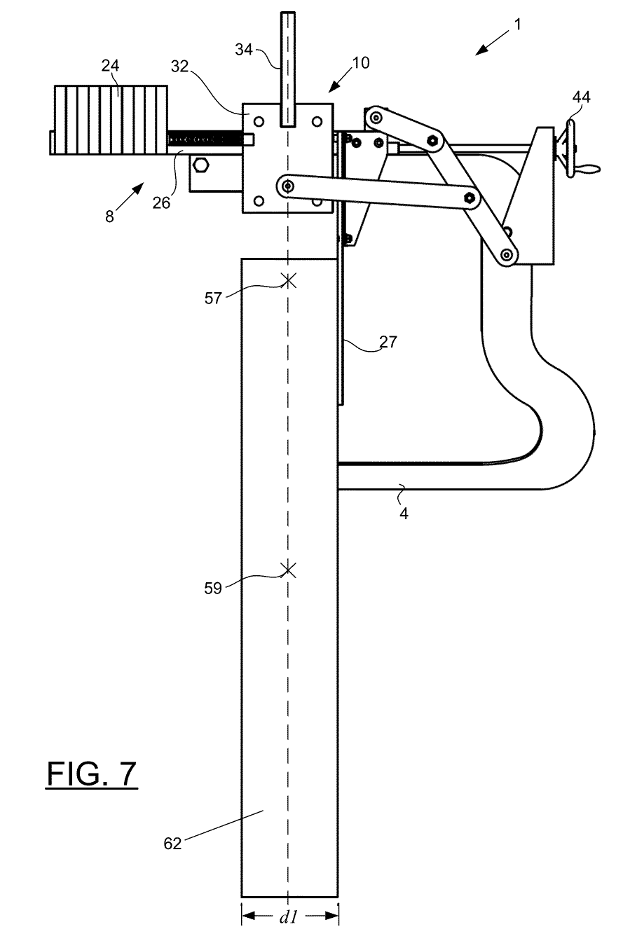

For example, with reference to FIG. 5, when the handle 44 has been rotated to move the counterweight assembly 8, to its most forward position the centre of gravity 57, of the lifting hook 1, is also moved forward. However since the lifting point assembly is also brought to its most forward position the lifting lug is brought over the centre of gravity of the lifting hook as indicated by the dashed line. As the handle 44 is rotated in a reverse direction the counterweight assembly is brought to its most rearward position, as shown in FIG. 6. At the same time, by virtue of the linkage, 14, the lifting assembly is also moved rearward about half the distance that the counterweight assembly 8 has been moved. As the counterweight assembly 8 moves the centre of gravity 57 of the lifting frame 1, is brought rearward but once again, due to the motion of the lifting point assembly 10, the lifting lug 34, is kept over the centre of gravity 57, of the lifting frame. Consequently, provided the lower arm 4 is designed to be horizontal, it will remain so, i.e. level, as the handle 44 is rotated with the lifting frame in an unloaded state. It will therefore be realized that the mass of the counterweight 24, length of the slider 26, and the dimensions of the first and second slider-cranks 52, 54, are chosen so that the lifting lug 34, remains above the centre of gravity 57, of the lifting frame throughout the constrained motion of the lifting assembly 8, and counterweight assembly 10.

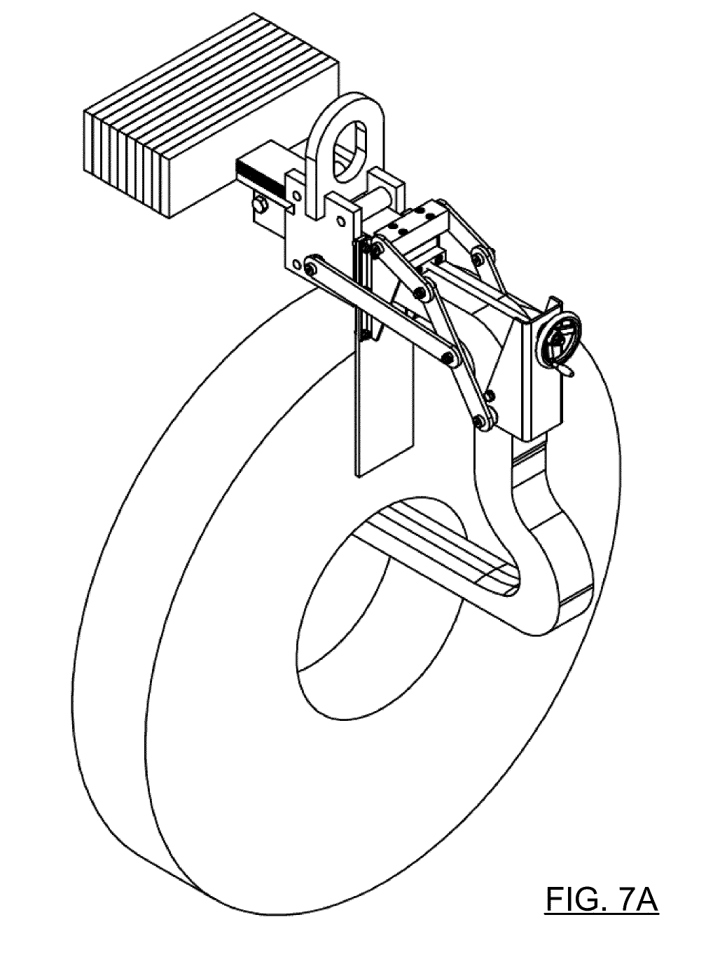

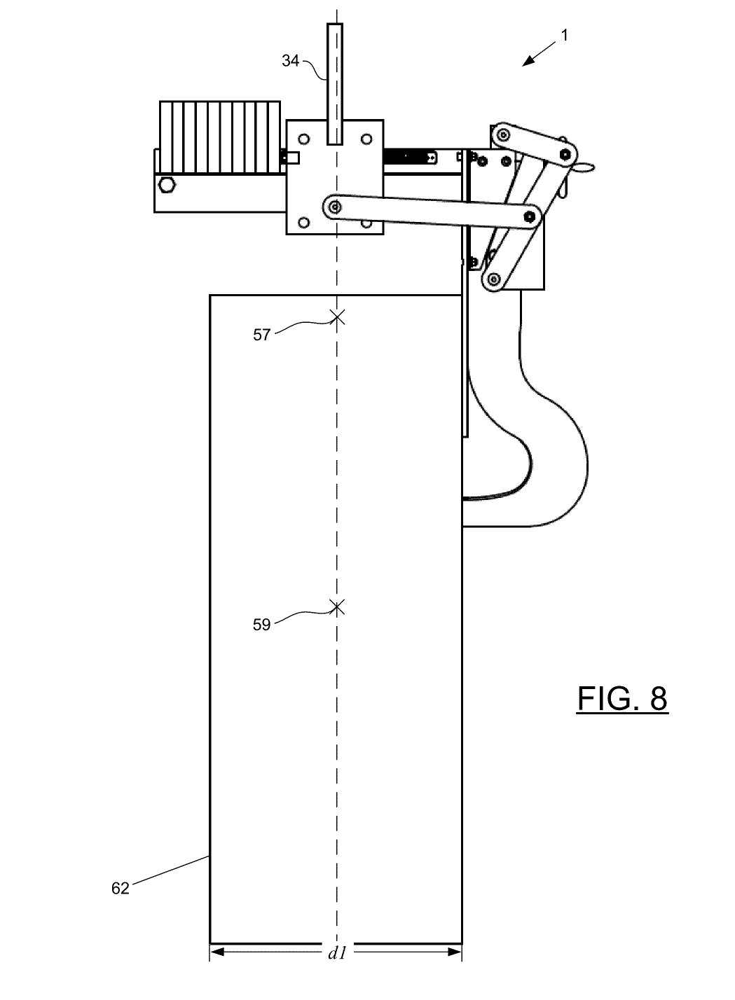

Referring now to FIGS. 7 and 8, in order that the lower arm 4 remains horizontal when a coil is loaded there upon it is necessary to locate the coil at a correct distance along the lower arm 4 so that the centre of gravity 59, of the coil 62, is vertically inline with the lifting lug 34, and so also vertically in line with the centre of gravity 57 of the frame.

An aid to correctly positioning the coil is provided by markings, such as ruler 60 on the side of the slider arm 26. For example, when it is desired to load a coil 62 of width d1 as shown in FIG. 7, the handle 44 is firstly rotated so that an edge of plate 32 of the slider assembly 10, is brought level with a predetermined marking on ruler 60, corresponding to coil width d1. In doing that the coil placement member 27, is moved twice the distance that the lifting lug 34, is moved. Consequently, when the coil 62, is then loaded on to the lower arm 4 and brought to abut the coil placement member 27, it will be located with its midline underneath the lifting lug so that the coil's centre of gravity 59, is beneath lug 34, and also beneath the frame's center of gravity 57. Similarly, a wider coil, such as coil 64 shown in FIG. 8, having a width d2 will also be located with its midline beneath the lifting lug. In both cases, upon the lifting hook being raised by a line attached to the eye of the lifting lug 34, the lifting hook 1 will remain level. Consequently the coil can then be readily brought to the uncoiling mandrel and loaded thereon.

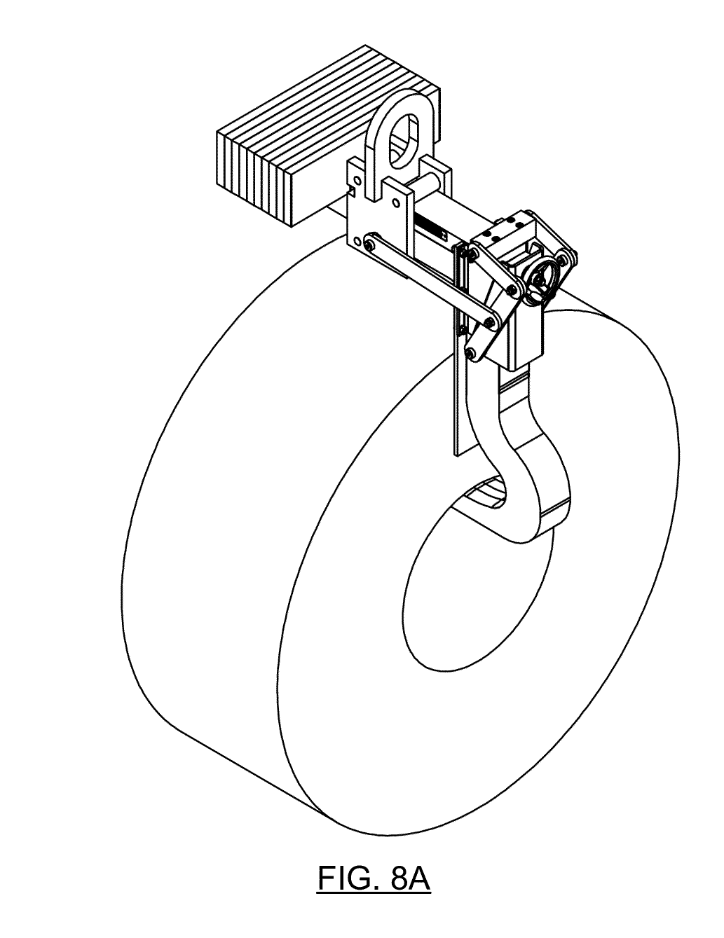

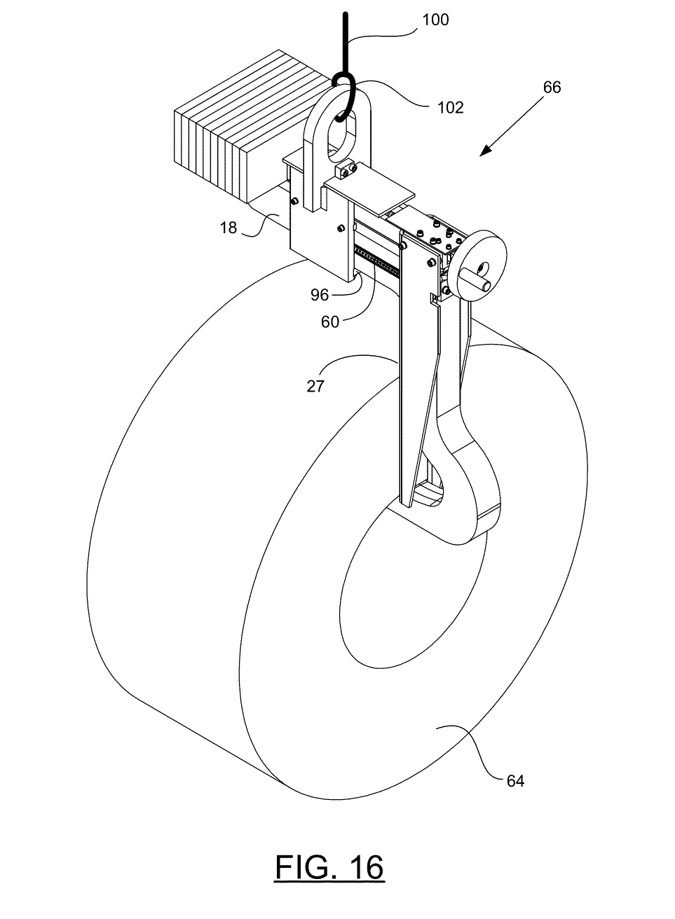

Referring now to FIG. 9, there is depicted a lifting hook 66 according to a preferred embodiment of the present invention for lifting coils of varying widths. The lifting hook 66 includes a lifting frame 2 that has a lower arm 4 having a forward end 6 for penetrating a lumen of a coil, such as coil 64 of FIG. 16 or coil 62 of FIG. 7. The lifting frame 2 also includes an upper arm 18. The lower arm 4 and the upper arm 18 are joined by a substantially vertical rearward spacing portion 12.

A counterweight assembly 8 is located over the upper arm 18 and arranged to slide through a range of positions over the upper arm and so also above the lower arm 4. The counterweight assembly 8 includes a forwardly positioned counterweight 24 and a coil placement member 27. The coil placement member 27 comprises a plate that depends downward from the counterweight assembly and which is designed to abut against a face of the coil as will be explained shortly. The coil placement member and the counterweight are located at rear and forward ends of counterweight assembly 8 respectively.

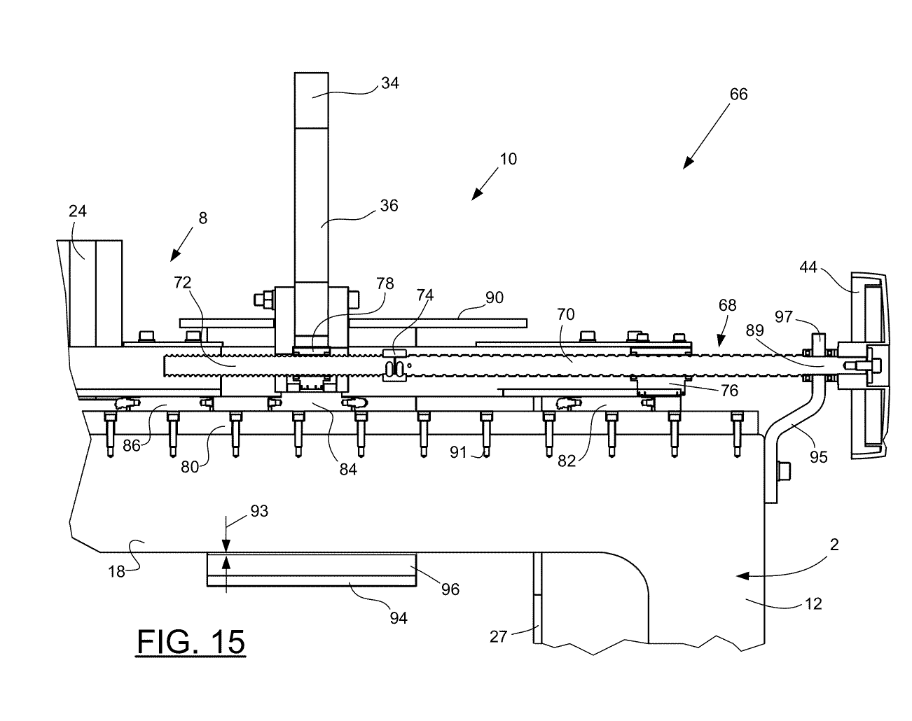

As best seen in FIG. 15, the counterweight assembly 8 includes a first linear bearing 86, which is mounted beneath and adjacent to counterweight 24 and a second linear bearing 82 which is located beneath the rearward end of the counterweight assembly 8. The first and second linear bearings 86, 82 slide over a bearing rail 80 which is fastened to the top arm 18 of the lifting hook 2 by means of a plurality of bolts 91.

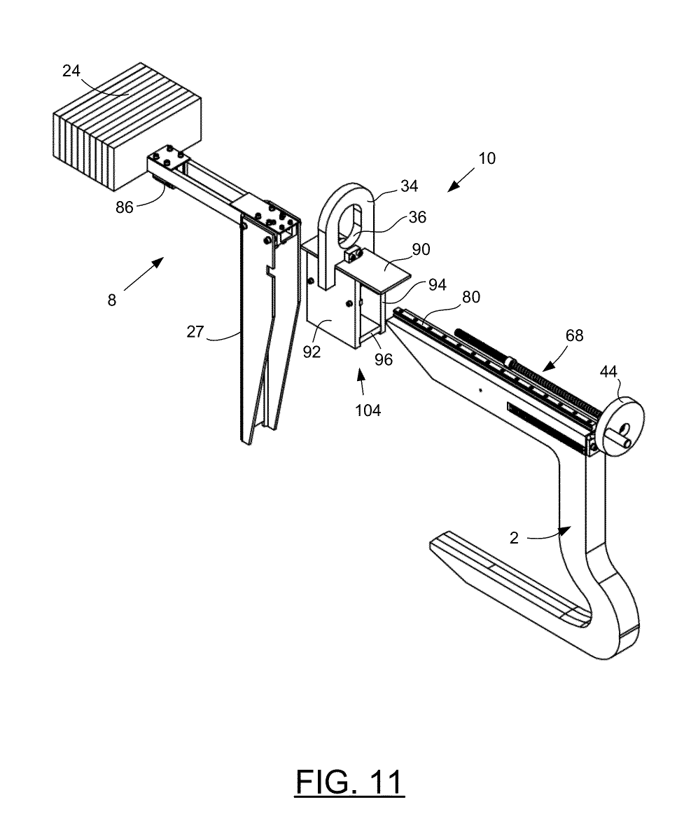

At the rear of the counterweight assembly 8 there is fastened a recirculating ball bearing nut 76 which threadedly engages first leadscrew 70 of leadscrew assembly 68. As can be seen in FIG. 12, the leadscrew assembly 68 comprises the first leadscrew 70 which is rigidly and non-rotationally fastened end-to-end to a second leadscrew 72 by a coupler 74. Of course, the entire leadscrew assembly might be formed as a single piece if desired. The first leadscrew 70 has a pitch that is twice that of the second leadscrew 72.

The outer end of first leadscrew 70 terminates in a cylindrical neck portion 89 that is supported in yoke 90 and is fastened to handle 44. Accordingly, by rotating the handle 44 the leadscrew assembly 68 rotates and the counterweight assembly 8 is moved along the rail 80 by virtue of first leadscrew 70's threaded engagement with the ball bearing nut 76. Consequently, rotation of the handle 44 causes movement of the placement member 27 and counterweight 24, back and forth along the top of arm 18 of the C-hook 2.

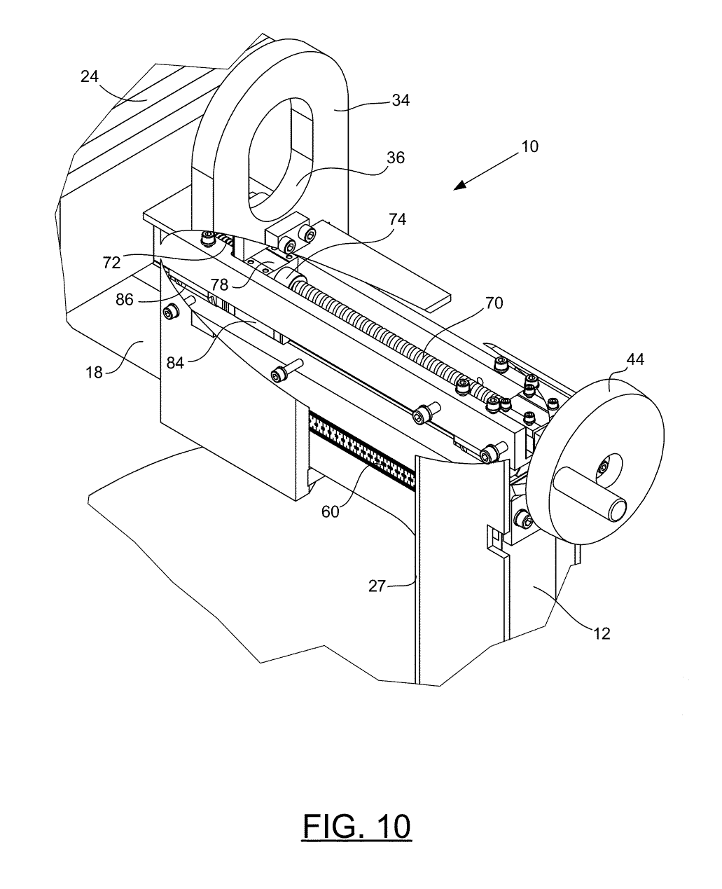

Referring again to FIGS. 9 to 11, a lifting point assembly 10 is arranged to move intermediate the counterweight 24, and the rearward portion 12 of the frame. The lifting point assembly 10 includes a lifting lug 34 that extends upwardly from a box 104 (identified in FIG. 11) that fits about the upper arm 18 of the C-hook 2.

The box is formed of a top plate 90, side plates 92, 94 which depend from opposite sides of the top plate 90 and a bottom plate 96 which locates underneath the upper arm 18 of the C-hook 12 and is connected at opposite ends towoard the lower edges of the side plates.

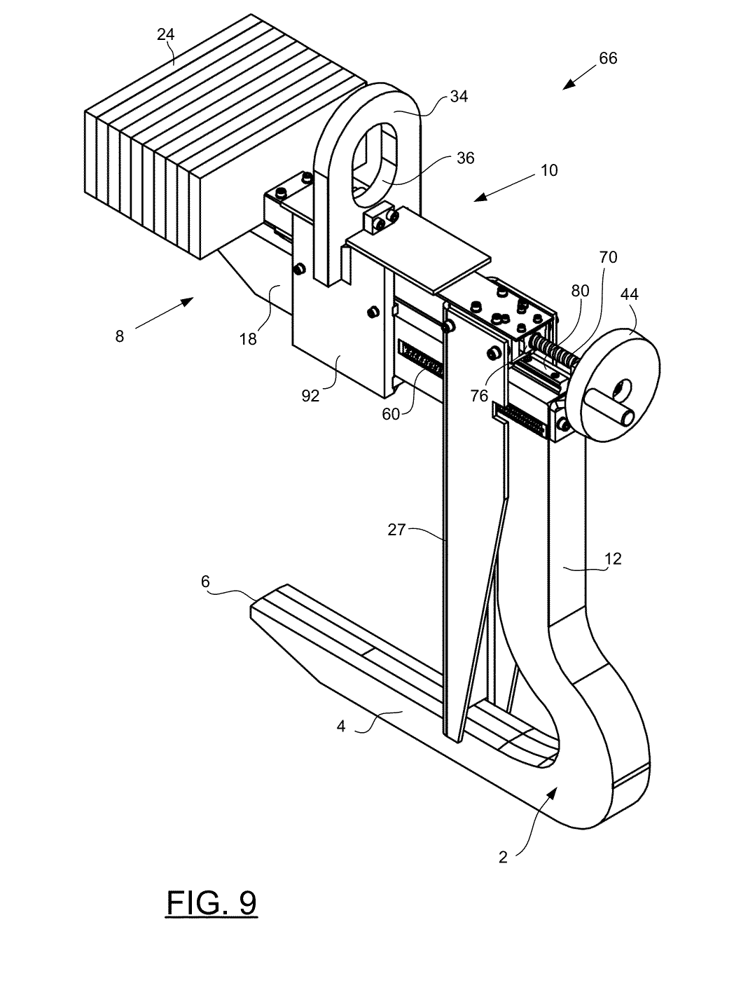

As may be seen in FIGS. 10 and 15, a linear bearing 84 is mounted inside the box section and slides on bearing rail 80 along the top of the C-hook 2. Above the linear bearing 84 there is mounted a recirculating ball bearing nut 78 which threadedly engages second leadscrew 72 of leadscrew assembly 68.

Accordingly, by rotating the handle 44 the leadscrew assembly 68 rotates and the lifting assembly 10 is moved along the rail 80 by virtue of second leadscrew 72's threaded engagement with the ball bearing nut 78. Consequently, rotation and anti-rotation of the handle 44 causes movement of the lifting assembly, including lifting hook 34, back and forth along the top of arm 18 of the C-hook 2.

The leadscrew assembly 68, and first and second bearing nuts 76, 78 comprise a mechanical linkage that constrains movement of the lifting point assembly 10 relative to the counterweight assembly 8.

Since the pitch of the first leadscrew 70 is twice the pitch of the second leadscrew 72 rotating the handle 44 to cause sliding of the counterweight assembly 8 through a given distance causes the lifting point assembly 10 to slide through half that distance.

When the handle 44 has been rotated to move the counterweight assembly 8, to its most forward position the centre of gravity of the lifting hook 66, is also moved forward. However since the lifting point assembly is also brought to its most forward position the lifting lug 34 is brought over the center of gravity of the lifting hook. As the handle 44 is rotated in a reverse direction the counterweight assembly is brought to its most rearward position as shown in FIG. 10. At the same time, by virtue of the mechanical linkage comprising leadscrew assembly 68 and bearing nuts 76 and 78, the lifting assembly is also moved rearward about half the distance that the counterweight assembly 8 has been moved.

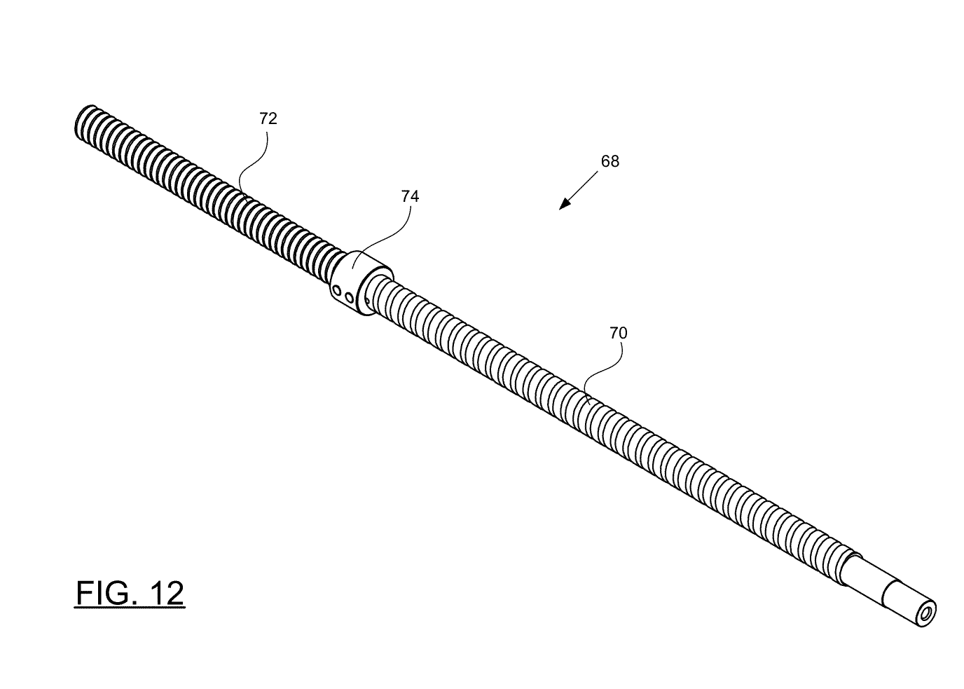

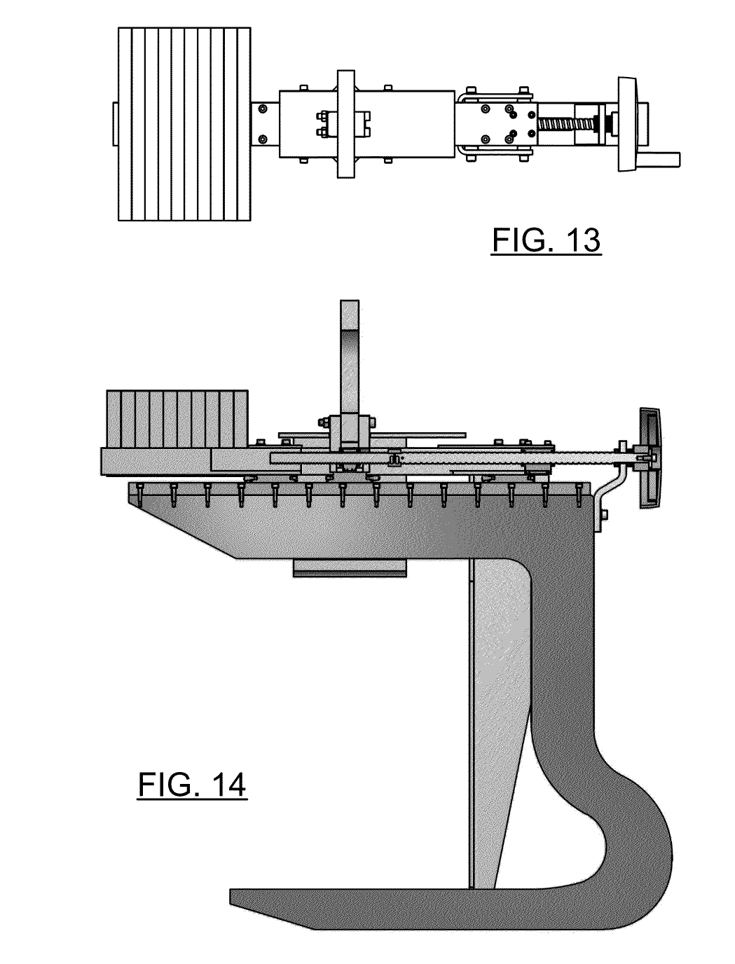

As the counterweight assembly 8 moves rearward the center of gravity of the lifting frame 66, is also brought rearward but once again, due to the motion of the lifting point assembly 10, the lifting lug 34, is kept over the centre of gravity, of the lifting frame. Consequently, provided the lower arm 4 is designed to be horizontal when lifted, it will remain so, i.e. level, as the handle 44 is rotated with the lifting frame in an unloaded state. It will therefore be realized that the lifting lug 34, remains above the center of gravity, of the lifting frame throughout the constrained motion of the lifting assembly 8, and counterweight assembly 10. The above procedure is entirely analogous to that discussed with reference to FIGS. 6 and 7 for the first embodiment save that the mechanical linkage between the counterweight assembly and the lifting assembly is different in the preferred embodiment of FIGS. 9 to 16 since it is based upon the leadscrew assembly 68 rather than the crank sliders of the first embodiment.

Referring now to FIG. 16, in order that the lower arm 4 remains horizontal when a coil 64 is loaded thereupon it is necessary to locate the coil at a correct distance along the lower arm 4 so that the centre of gravity, of the coil 64, is vertically inline with the lifting lug 34, and so also vertically in line with the center of gravity of the overall frame 66.

An aid to correctly positioning the coil placement member 27 prior to loading a coil is provided by markings, such as ruler 60 on the side of the upper arm 18 of the C-hook 2.

The use of the ruler for the embodiment of FIGS. 9 to 16 is analogous to that previously described for the first embodiment in relation to FIG. 7. In each case, when a coil is loaded on to the lower arm 4 and brought to abut the coil placement member 27, it will be located with its midline underneath the lifting lug so that the coil's center of gravity is beneath lug 34, and also beneath the frame 66 center of gravity. Therefore, upon the lifting hook being raised by a line 100 attached to the eye of the lifting lug 34 by shackle 102, the lifting hook 66 will remain level.

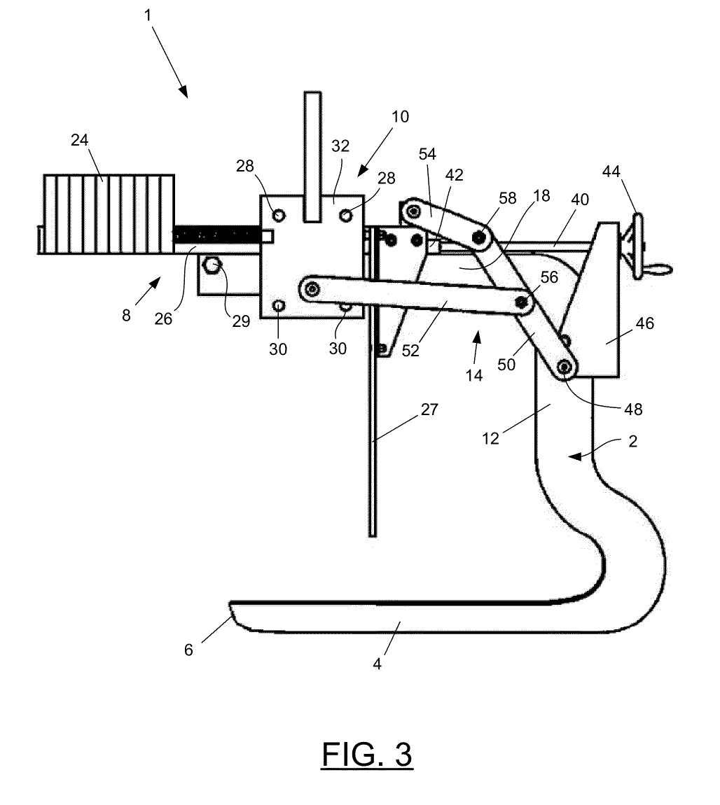

As the loaded hook 66 is lifted the small clearance gap 93 (visible in FIG. 15) between the underside of the upper arm 18 of the lifting hook 2 and the bottom plate 96 closes and the two press firmly together so that no sliding of the lifting assembly is now possible. Consequently the coil can then be readily and safely brought to the uncoiling mandrel, shown in FIG. 2, and loaded thereon.

In compliance with the statute, the invention has been described in language more or less specific to structural or methodical features.

The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims and Summary of Invention, appropriately interpreted by those skilled in the art.

What is claimed is:

1. A lifting hook for lifting coils of varying widths comprising:
a lifting frame including a lower arm having a forward end for penetrating a lumen of a coil;
a counterweight assembly arranged to move through a range of positions above the lower arm;
a lifting point assembly arranged to move intermediate a counterweight of the counterweight assembly and a rearward portion of the frame; and
a mechanical linkage constraining movement of the lifting point assembly relative to the counterweight assembly,
wherein the counterweight assembly is constrained to move at a greater speed than the lifting point assembly.

2. A lifting hook according to claim 1, wherein the mechanical linkage is arranged to maintain the lifting point assembly over a center of gravity of the lifting hook throughout said range of positions of the counterweight assembly.

3. A lifting hook assembly according to claim 1, wherein the lifting hook includes a coil placement member fast with the counterweight assembly for abutting an inner side of the coil to thereby position the counterweight assembly relative to the coil in a loaded configuration.

4. A lifting hook according to claim 1, wherein the linkage is arranged to constrain the movements of the lifting point assembly relative to the counterweight assembly so that the lifting point assembly moves half a distance moved by the counterweight assembly in use.

5. A lifting hook according to claim 1, wherein the mechanical linkage comprises first and second crank sliders interconnecting the counterweight assembly and the lifting assembly.

6. A lifting hook according to claim 1, wherein the mechanical linkage comprises a leadscsrew assembly including a first leadscrew and a second leadscrew having first and second pitches respectively wherein the first leadscrew is threadedly engaged by the counterweight assembly and the second leadscrew is threadedly engaged by the lifting assembly.

7. A lifting hook according to claim 6, wherein the second pitch is twice the first pitch.

8. A lifting hook according to claim 3, including markings for positioning the placement member at locations corresponding to coils of predetermined width.

9. A lifting hook for lifting coils of varying widths comprising:
a lifting frame including a lower arm having a forward end for penetrating a lumen of a coil;
a counterweight assembly arranged to move through a range of positions above the lower arm;
a lifting assembly arranged to move intermediate a counterweight of the counterweight assembly and a rearward portion of the frame; and
a leadscrew assembly including a first leadscrew and a second leadscrew having first and second pitches respectively wherein the first leadscrew is threadedly engaged by the counterweight assembly and the second leadscrew is threadedly engaged by the lifting assembly and wherein the second leadscrew pitch is twice the first leadscrew pitch.

10. A lifting hook assembly according to claim 9, including a coil placement member extending downward from the counterweight assembly for abutting an inner side of the coil to thereby position the counterweight assembly relative to the coil in a loaded configuration; and
coil positioning markings upon the lifting frame for assisting an operator to bring the coil placement member to a position for balanced loading of coils of predetermined width.
